(19) United States
(12) Patent Application Publication
(10) Pub. No.: US 2010/0028244 A1
(43) Pub. Date: Feb. 4, 2010

(54) FULLERENE MANIFOLD AND MANUFACTURING METHOD OF THE SAME HAVING CHARACTERISTIC OF WHITE PHOTOEMISSION

(75) Inventor: Jeung Sun Ahn, Seoul (KR)

Correspondence Address: HAHN & VOIGHT PLLC, 1012 14TH STREET, NW, SUITE 620, WASHINGTON, DC, 20005, US

(73) Assignee: INDUSTRY ACADEMIC COOPERATION FOUNDATION OF KYUNGHEE UNIVERSITY, Gyeonggi-do (KR)

(21) Appl. No.: 12/302,833

(22) PCT Filed: May 30, 2007
(86) PCT No.: PCT/KR07/02620

§ 371 Date: Apr. 15, 2009

(30) Foreign Application Priority Data
May 30, 2006 (KR) 10-2006-0048477

(51) Int. Cl. C01B 31/00; B01J 19/12

(52) U.S. Cl. 423/445 B; 204/157.41; 977/734; 977/842

(57) ABSTRACT

A fullerene manifold with a size of several to tens of nanometers, having a characteristic of white photoemission of a closed shell structure, the fullerene manifold being formed by dissolving a substance of fullerene monomers such as C₆₀, in a solvent such as Toluene, solidifying the solution to form a fullerene assembly, and then, optically pumping the fullerene assembly, and a method of manufacturing the fullerene manifold are provided.

### TECHNICAL FIELD

The present invention relates to a fullerene manifold having a characteristic of white photoemission, and more particularly, to a fullerene manifold with a size of several to tens of nanometers, having a characteristic of white photoemission of a closed shell structure, the fullerene manifold being formed by dissolving a fullerene monomer such as C₆₀, in a solvent such as Toluene, solidifying the solution to form a fullerene assembly, and then, optically pumping the fullerene assembly, and a method of manufacturing the fullerene manifold.

### BACKGROUND ART

A fullerene is a substance formed by only carbon, and has an intermediate structure between a graphite structure and a diamond structure. The fullerene is formed with hexagonal ring structure, partially having pentagonal ring structure.

In relation to the fullerene, substances which are obtained by replacing part of carbon atoms with other elements, or by adding other elements to the fullerene have also been well known. In addition, substances in which other elements are included in a fullerene, such as a substance obtained by including metal atoms inside a ball-shaped fullerene, and a structure having metal atoms in which oxygen is included between fullerene molecules have also been well known.

Representative fullerenes include C₆₀, and in addition, C₇₀, C₇₆, C₇₈, C₈₂, C₈₄, C₂₄₀, C₅₄₀, and C₇₂₀, have also been known. Each of the fullerenes has a ball state in which the inside is empty. Also, fullerenes in tube states have also been known. The ball-state fullerenes are more noteworthy and fullerenes will now be explained with more focus on the ball-state fullerenes.

The fullerene exists as a solution or a single crystal. Solvents dissolving the fullerene include benzene, toluene, CS₂, acetone, tricrene, and chlorobenzene. The fullerene has a degree of freedom of rotation both as a solution and as a single crystal.

For example, in a single crystal at room temperature, a fullerene molecule, i.e., a fullerene monomer, does not have only the freedom of translation, but rotates by a thermal motion. This relates to the fact that the fullerene has an isotropic ball state in which the bonding between fullerene molecules is weak and the anisotropy of the potential of the bonding is small. Accordingly, the bonding between fullerene molecules in a solid body is mainly van der Waals bonding caused by interaction of π electrons.

As an application of the fullerene, lithography has been highlighted. Since the fullerene has a sublimation property and can form a thin film, if a latent image can be formed and developed on this thin film, the fullerene can be applied for lithography.

### DISCLOSURE OF INVENTION

### Technical Problem

In relation to the characteristics of the fullerene and its application fields as described above, research activities have been underway, but so far, the characteristic of white photoemission of the fullerene has not been known and the fullerene has never been used for a display device such as an organic electroluminescent (EL) display.

Accordingly, the present invention provides a fullerene manifold having a characteristic of white photoemission in the whole range of visible rays, the fullerene manifold being formed by the covalent bonding between fullerene molecules in a fullerene assembly, by dissolving a substance of fullerene monomers in a single solvent to form a fullerene solution, then, forming the fullerene assembly through a solidifying process, and optically pumping the fullerene assembly by irradiating a laser.

### Technical Solution

According to an aspect of the present invention, there is provided a method of manufacturing a fullerene manifold having a characteristic of white photoemission, the method including: generating a fullerene assembly by solidifying a fullerene solution obtained by dissolving a substance or fullerene monomers in a single solvent; and optically pumping the generated fullerene assembly by irradiating a laser to the fullerene assembly.

According to another aspect of the present invention, there is provided a fullerene manifold having a characteristic of white photoemission which is generated by the method.

### Advantageous Effects

By generating a fullerene assembly in a process of dissolving a substance of fullerene monomers in a signal solvent and solidifying the solution, and manufacturing a fullerene manifold through an optical pumping process by irradiating a laser, the fullerene manifold having the characteristic of white photoemission according to the present invention can be made to have the characteristic of white photoemission in the whole range of visible rays.

Also, since the fullerene manifold according to the present invention has the characteristic of white photoemission in the whole range of visible rays, the fullerene manifold can be applied to a display device such as an organic EL display.

### BRIEF DESCRIPTION OF THE DRAWINGS

FIG. 1 is a graph illustrating changes in a photo luminescence (PL) spectrum with respect to light irradiation time of a fullerene manifold which is manufactured by optically pumping a fullerene assembly manufactured according to an embodiment of the present invention.

### MODE FOR THE INVENTION

The present invention relates to a fullerene manifold having a characteristic of white photoemission in which fullerene monomers are bonded together such that the degrees of freedom of rotation of the fullerene monomers can be removed.

The fullerene manifold having the characteristic of white photoemission is manufactured, by solidifying a fullerene solution obtained by dissolving fullerene monomers in a signal solvent, thereby forming a fullerene assembly in the solidifying process, and optically pumping the fullerene assembly by irradiating a laser to the fullerene assembly.

Also, the fullerene manifold may also be manufactured by forming a fullerene assembly by adding a poor solvent of a fullerene to a substance of fullerene monomers solution, and optically pumping the fullerene assembly by irradiating a laser to the fullerene assembly.

As the solvent of the fullerene monomer, any one of toluene, benzene, and CS₂ may be used, and in addition, acetone, tricrene, or chlorobenzene that can dissolve the fullerene can also be used as a solvent. Also, since the fullerene assembly which is generated in the process of solidifying the fullerene monomer solution obtained by dissolving the fullerene monomers in the solvent, relies on the density of the fullerene monomer dissolved in the solvent, the density of the fullerene monomer is preferably be maintained at equal to or greater than 1×10⁻³ mol/L in any solvent.

The assembly of the fullerene indicates a state in which several to hundreds of the fullerene monomers, or several to tens of fullerene monomers when the number is small, are bonded together in the solution by the van der Waals force.

Also, by maintaining the density of the fullerene monomers in the fullerene monomer solution at equal to or greater than 2.5×10⁻³ mol/L for a toluene solvent, at equal to or greater than 1.5×10⁻³ mol/L for a benzene solvent, and at equal to or greater than 1.5×10⁻³ mol/L for a CS₂ solvent, the fullerene monomers become the fullerene assembly after the solidification or addition of the difficult solvent.

The fullerene assembly which is formed in the solidifying process of the fullerene monomer solution as described above, has a size of several to tens or nanometers, and has a closed shell structure. The fullerene assembly which is formed by mixing with the difficult solvent has a size of roughly hundreds of nanometers, and has an FCC structure as that of the bulk state.

The fullerene manifold manufactured through the optical pumping process by irradiating a laser to the fullerene assembly generated as described above has a different size and structure in the aspect of the properties according to the method of forming the fullerene assembly.

In particular, in the case of the fullerene manifold generated by optically pumping the fullerene assembly manufactured through the solidifying process of the fullerene monomer solution, the fullerene manifold has the characteristic of white photoemission in the whole range of the visible rays.

However, in the case where the fullerene assembly generated by mixing a difficult solvent with the fullerene monomer solution is manufactured as the fullerene manifold through an optical pumping process, the characteristic of the white photoemission cannot be found in the fullerene manifold.

In this case, a laser with a wavelength (355 nm) three times the wavelength of a YAG laser or an Ar ion laser (514.5 nm) is used as the laser beam irradiated for the optical pumping of the fullerene assembly.

According to an embodiment of the method of manufacturing the fullerene manifold having the characteristic of the white photoemission, a substance of fullerene monomers may be dissolved in a benzene solvent, thereby forming a substance of fullerene monomers solution with a density equal to or greater than 1×10⁻³ mol/L, and then, by solidifying the fullerene monomer solution at a temperature equal to or below 77K which is the freezing point of benzene, the fullerene assembly may be generated.

Next, by irradiating a laser beam (laser power density: 15.8 mW/mm²) with a wavelength (355 nm) three times the wavelength of a YAG laser to the fullerene assembly, the fullerene assembly is optically pumped and the fullerene manifold is generated.

In this case, according to the time for irradiating the laser beam to the fullerene assembly, a photo luminescence (PL) spectrum was measured so that it is checked whether or not a fullerene manifold has been generated.

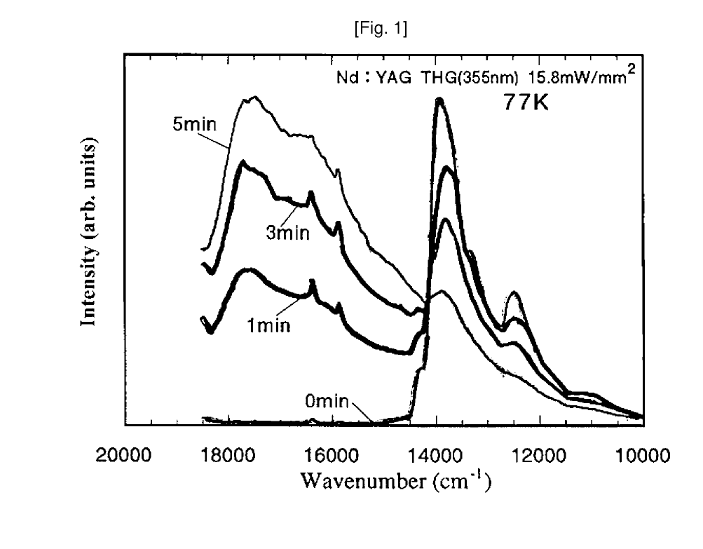

FIG. 1 is a graph illustrating changes in a PL spectrum with respect to the time for irradiating the laser in the optical pumping process of the current embodiment. As illustrated in FIG. 1, the PL spectrum having the time for irradiating the laser beam being 0 minute, has a peak value at wavenumber 1400 (wavenumber: the number of waves per cm⁻¹). Based on this, it can be known that with the increasing irradiation time of the laser beam, the PL spectrum of the fullerene assembly changes to that of the fullerene manifold having a peak value around wavenumber 1800. When the time for irradiating the laser beam exceeds five minutes, the PL spectrum does not have a peak value at wavenumber 1400, and therefore it can be known that the fullerene assembly has changed to the fullerene manifold having the characteristic of white photoemission in the whole range of the visible rays.

For your information, the time in which the fullerene assembly changes to the fullerene manifold may rely on the strength (power density) of the irradiation of the laser beam and the wavelength of the laser, and the five minutes is the time taken when the laser beam with a wavelength (355 nm) three times the wavelength of a YAG laser was irradiated at a laser power density of 15.8 mW/mm².

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

1. A method of manufacturing a fullerene manifold comprising:
generating a fullerene assembly by solidifying a fullerene solution obtained by dissolving a substance of fullerene monomers in a single solvent; and
optically pumping the generated fullerene assembly, by irradiating a laser to the fullerene assembly.

2. The method of claim 1, wherein the solvent of the fullerene monomer is any one of benzene, toluene, CS₂, acetone, tricrene, and chlorobenzene.

3. The method of claim 1, wherein the density of the fullerene monomer dissolved in the solvent is at least equal to or higher than 1×10⁻³ mol/L.

4. The method of claim 1, wherein the laser irradiated in the optical pumping is a YAG laser or Ar ion laser.

5. A fullerene manifold manufactured by the method of claim 1, and having a size of several or tens of nanometers and a closed shell structure.
